(19) United States
(12) Patent Application Publication
(10) Pub. No.: US 2010/0003860 A1
(43) Pub. Date: Jan. 7, 2010

(54) ASSEMBLY FOR PERMITTING POWER-OVER-INTERNET CONNECTION

(75) Inventors: Rafael Mateo Ferrus, Barcelona (ES); Albert Font Aranega, Badalona (ES)

Correspondence Address: BAKER & DANIELS LLP, 300 NORTH MERIDIAN STREET, SUITE 2700, INDIANAPOLIS, IN, 46204, US

(73) Assignee: TYCO ELECTRONICS AMP ESPANA SA, Barcelona (ES)

(21) Appl. No.: 12/298,825

(22) PCT Filed: Apr. 18, 2007
(86) PCT No.: PCT/GB07/01399

§ 371 Date: Oct. 28, 2008

(30) Foreign Application Priority Data
Apr. 28, 2006 (GB) 0608456.0

(51) Int. Cl. H01R 24/04

(52) U.S. Cl. 439/668

(57) ABSTRACT

An assembly for permitting “Power-over-Ethernet” (PoE) connection between a PoE control device and a component of a cabling network, the assembly comprising: a network connection device comprising a plurality of cable terminations each operatively connectable to a respective data cable for the transmission of data, each cable termination being operatively connected to a socket; and a PoE plug jack device directly connectable to a PoE control device or PoE power source, such that, when directly connected to the PoE control device or PoE power source, the PoE plug jack device receives power and/or power signals in dependence of the output of the PoE control device when connected to the PoE control device or PoE power source, the PoE plug jack device being engageable with a respective socket, and thereby operatively connectable to a said data cable via a data transmission path forming part of the network connection device.

This invention relates to an assembly for permitting “Power-over-Ethernet” (PoE) (also sometimes referred to as “power over LAN”) connection, and to a PoE plug jack device forming such an assembly.

PoE is a subject of rapidly growing interest at the present time. The technology involves the provision of electrical power using Ethernet cabling such as that defining a local area network (LAN).

A typical “Category 5” data transmission cable (which is a type very commonly used in LAN cabling applications) consists of four twisted pairs of conductor wire. These are used to transmit data in the form of voltages whose maximum and minimum values are dictated by internationally agreed standards.

It is possible to use data cables of this kind for the provision of electrical power as well as data, without reducing the ability of the cables simultaneously to transmit data reliably and without crosstalk.

This is achieved primarily through the use of both active control elements and certain passive components (such as centre-tapped secondary windings of transformers forming part of the LAN) that permit the connection of power supplies to the data cables. The active and passive components limit the voltages transmitted via the cables so that they lie within the maximum and minimum values permitted under the aforesaid standards.

In some applications of PoE technology the transmission of data and electrical power occurs simultaneously using the same pairs of the cables. In other applications there is a mix of uses such that some of the pairs are used for mixed data and power transmission and others are dedicated to the transmission of either power or data.

Various devices are capable of operating at the power levels provided using PoE technology. Such devices, if connected to the node of a LAN, may draw operating power from the network without any need for a separate connection to mains power. Such devices include internet protocol (IP) telephones, charge-coupled device (CCD) cameras, sensors of alarm systems, card readers and similar apparatuses. There is even available a personal computer that operates at the power levels available from a PoE arrangement.

Also a PoE-enabled network may provide backup power to devices, such as conventional personal computers, at times when mains power is unavailable. In such applications the active devices controlling the distribution of power over the LAN in question can be arranged to send network messages to devices connected at its nodes, thereby initiating modes of operation that minimise power consumption.

The advantages of providing power over a LAN or Ethernet are such that interest in this technology is growing rapidly. However, many buildings and other locations where network cabling is installed do not incorporate the active and passive components needed to permit the transmission of power.

The structured (i.e. built-in) cabling of a new building is nowadays intended to remain in use for 10-20 years. Therefore in the majority of applications it would be uneconomical to replace it with cabling incorporating the parts needed to provide Power over Ethernet transmission.

It is desirable to be able to upgrade the electronic components needed on a more frequent basis than the 10-20 year life of structured LAN cabling.

Thus overall there is a need to provide LAN components that allow upgrading of the LAN to incorporate electronics modules and parts as desired.

According to a first aspect of the invention there is provided an assembly for permitting “Power-over-Ethernet” (PoE) connection between a PoE control device and a component of a cabling network, the assembly comprising:
a network connection device comprising a plurality of cable terminations that are each operatively connectable to a respective data cable for the transmission of data, and a plurality of sockets, each cable termination being operatively connected to a respective socket; and
a PoE plug jack device directly connectable to a PoE control device or PoE power source, such that, when directly connected to the PoE control device or the PoE power source, the PoE plug jack device receives power and/or power signals dependent on the output of the PoE control device or PoE power source, the PoE plug jack device being engageable with a respective socket, and thereby operatively connectable to a said data cable via a data transmission path forming part of the network connection device.

The term “network connection device” as used herein includes but is not limited to a patch panel or similar device.

By means of the invention, it is possible to provide PoE connection to a single network component via a single socket forming part of the network connection device. This means that it is not necessary to provide PoE function to further sockets, or outlets, forming part of the network connection device.

In practice, it is usually the case that PoE function is not required at most of the outlets in a network connection device, and therefore the invention provides a simple and inexpensive way of providing a PoE function at a predetermined outlet only, thus enabling a new PoE LAN to be readily and economically upgraded to permit operation as a PoE installation.

This may be achieved even if the LAN cabling and the network connection device are conventional or largely conventional components, since the components needed to provide PoE functionality may be added by way of a PoE control device and a PoE plug jack device. The addition of these components to the LAN can occur after installation of the basic LAN elements. This is true even when for example the LAN includes a patch panel of an entirely conventional design, since the PoE plug jack device may be operatively connected to the patch panel.

Advantageously the assembly comprises a plurality of PoE plug jack devices each unit being engageable with a respective socket, thereby to permit PoE connection between a PoE control device or a PoE power source and a plurality of components of a cabling network.

Advantageously, the or each PoE plug jack device forming the assembly is directly connectable to a PoE control device or a PoE power source via a power cable.

The power cable thus enables the or each PoE plug jack device to be connected directly to a PoE control device or PoE power source independently of a patch panel and to thereby receive power and/or power signals in dependence of the output of the PoE control device.

Advantageously, the PoE plug jack device comprises a power port for operatively connecting the power cable to the or each PoE plug jack device. The power cable may thus be releasably connected to the PoE plug jack device via the power port.

The power port may be formed at any convenient location within the PoE plug jack device, and may, for example be located at a rear, front, side, top or bottom portion of the PoE plug jack device.

Alternatively, the power cable may be formed integrally with the PoE plug jack device.

When the network connection device comprises a patch panel, each outlet of the patch panel is defined by a respective outlet jack socket of the patch panel.

The present invention thus provides individual PoE plug jack devices for PoE upgrades to selected individual outlet jack sockets in an existing patch panel, each PoE plug jack device having its own attached power cable, or means for attaching its own power cable for direct connection to a PoE power source or controller.

This avoids the expense of providing PoE function to all outlets in the patch panel, when most outlets will not require PoE in practice, and the few that may later require it can be individually upgraded using the PoE plug jack devices of the present invention, when the need arises.

Preferred embodiments of the PoE plug jack device according to the invention may provide, in addition to the power connection, a jack sock duplicating the relevant socket of the patch panel into which the PoE plug jack device is inserted. This enables the jack socket in question to continue functioning as before, but with the advantageous addition of power supply to that individual socket.

Alternatively, the PoE plug jack device according to the present invention may provide a different socket or other connection means to enable the original patch panel socket to receive other kinds of data connection, again with the addition of individual power supply.

The PoE plug jack device according to the present invention may further comprise a connection interface a cabling management system such as AMPTRAC signals.

AMPTRAC™ is a real-time intelligent structured cabling management system that provides an infrastructure management system for use in a network such as a LAN.

Conveniently the or each PoE plug jack device comprises a male plug portion engagable with the respective socket of the patch panel to operatively connect the or each PoE plug jack device to the network connection device. This allows the or each PoE plug jack device to be directly connected to the network connection device via an appropriate socket/outlet whenever required.

Conveniently, the or each PoE plug jack device further comprises a network port for operatively connecting a patch cable to the PoE plug jack device.

By means of the network port, it is therefore possible to connect a network component to the network connection device via a patch cable.

Advantageously, the or each PoE plug jack device comprises a housing within which the male plug portion is operatively connected, and to which a power cable is operatively connectable.

The power cable may be connected directly to both the housing of the PoE plug jack device according to the invention, and to the PoE control device. Alternatively, the cable may comprise a plug formed at either end of the cable, a first plug being connectable with the PoE plug jack device, and a second plug being connectable to the PoE control device.

In embodiments of the assembly in which the or each PoE plug jack device includes a power port for allowing a power cable to be connected to the PoE plug jack device, the power port may be formed in the housing.

In embodiments of the invention in which the or each PoE plug jack device includes a network port for allowing a patch cable to be connected to the PoE plug jack device, the network port may be formed in the housing.

By means of the housing therefore a data cable operatively connected to a socket with which a PoE plug jack device is engaged, and a power cable connecting the PoE plug jack device to PoE control device or PoE power source, may each be operatively connected to the housing of the PoE plug jack device.

In embodiments of the invention in which the or each PoE plug jack device includes a network port, a patch cable may also be operatively connected to the housing.

In such embodiments, a patch cable, in addition to the male plug portion and power cable, may be operatively connected to a PoE control device or PoE power source.

Advantageously, the PoE plug jack device includes, within the housing, an electronics section having one or more of:
a filter;
a combiner;
a separator;
an inductance;
a sub-band communication apparatus;
an indicator apparatus; and/or
a power management device operatively connected to the male plug portion of the PoE plug jack device.

Since both the male plug portion and the power cable may be operatively connected to the housing of the PoE plug jack device, both the male plug portion and the power cable may also be operatively connected to the electronics section of the PoE plug jack device.

Similarly, in embodiments of the invention in which the PoE plug jack device comprises a network port, the network port is formed in the housing to allow a patch cable to be operatively connected to the electronics section.

An out-of-band (sub-band) communications apparatus has been developed that includes first and second data lines arranged in a differential pair. The data lines convey high speed data within a first frequency range and out of band data within a second frequency range that differs from the first frequency range. The apparatus also includes a band pass filter coupled to the first and second data lines. The filter passes the out of band data only, and blocks the high speed data. The apparatus also includes a device coupled to said band pass filter and configured to at least one of transmit and receive out of band data.

Certain embodiments of such an arrangement may also include a transformer having a centre power tap for one of adding and removing power from the first and second data lines. Alternatively, the filter may include a digital signal processor and an analog to digital converter configured to convert the out of band data to a digital signal.

Certain other variants on this arrangement may also include a filter configured to pass frequencies below 100 kilohertz. Optionally, the second frequency range of the apparatus may be between 100 hertz and 100 kilohertz. Alternatively, the second frequency range of the apparatus may be between 100 hertz and 20 kilohertz.

Such apparatuses may be incorporated into or may form the operational part of the PoE plug jack device of the invention and/or a PoE control device for use with the invention. The scope of the invention therefore embraces all arrangements including sub-band communication apparatuses as described.

Operatively connecting a patch cable to the electronics section of the PoE plug jack device allows the effective creation of a PoE arrangement.

Also the connection of the patch cable to the electronics section of the PoE plug jack device allows the co-ordination of e.g. network messages generated by the PoE control device with those generated elsewhere (for example by a server connected to control the LAN, or from a LAN switch/repeater).

According to a second aspect of the invention there is provided a PoE plug jack device directly connectable to a PoE control device or PoE power source, such that the PoE plug jack device receives power and/or power signals dependent on output of the PoE control device when directly connected to the PoE control device or PoE power source, and engageable with a respective socket of a network connection device having a plurality of cable terminations that are each operatively connectable to a respective data cable for the transmission of data, each cable termination being operatively connected to a respective socket, such that engagement of the PoE plug jack device with the respective socket results in connection of the PoE plug jack device with a said data cable via a data transmission path forming part of the network connection device.

Optional features of the PoE plug jack device according to the second aspect of the invention are as set out hereinabove in relation to those aspects of the invention when considered as part of the assembly of the first aspect of the invention.

According to a third aspect of the present invention there is provided a PoE plug jack device for providing a PoE connection to predetermined individual outlet jack sockets in an existing patch panel, each PoE plug jack device having its own attached power cable, or means for attaching its own power cable, for direct connection to a PoE power source or PoE control device the device further comprising a connector for operatively connecting a network connection device to the PoE plug jack device, and a power port for operatively connecting the power cable to the PoE plug jack device.

Optional features of the PoE plug jack device according to the third aspect of the present invention are as set out hereinabove in relation to those aspects of the invention when considered as a part of the assembly of the first aspect of the invention.

There now follows a description of a preferred embodiment of the invention, by way of non-limiting example, with reference being made to the accompanying drawings in which:

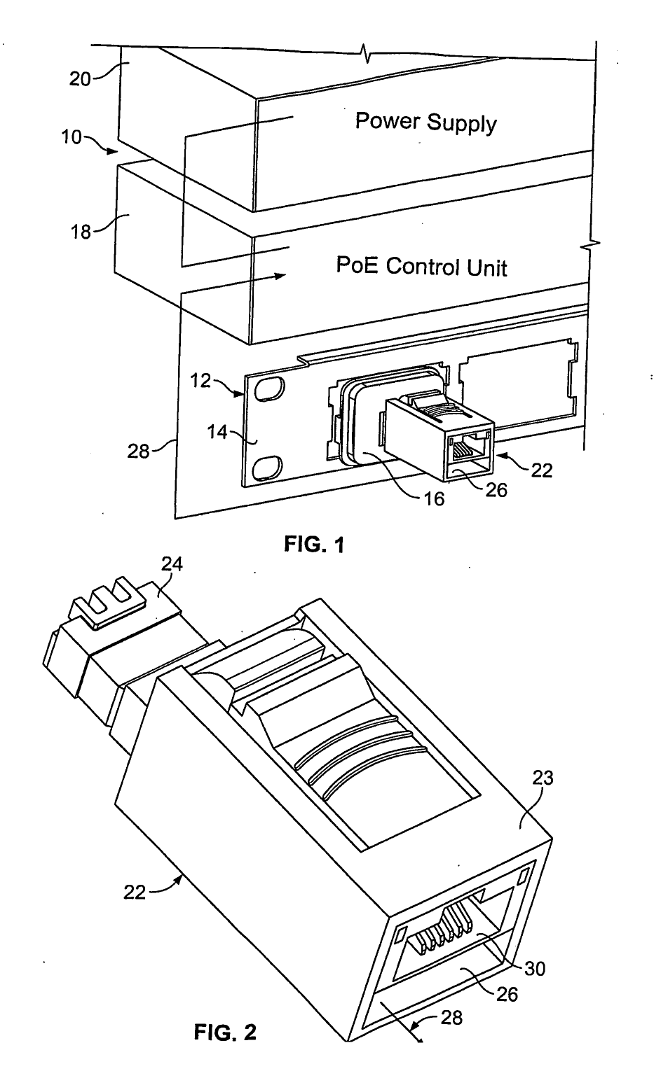

FIG. 1 is a schematic representation of a part of an assembly according to the first aspect of the present invention; and

FIG. 2 is a schematic representation of an embodiment of a PoE plug jack device according to the second aspect of the present invention forming part of the assembly of FIG. 1.

Referring first to FIG. 1, there is shown an assembly 10 according to the first aspect of the present invention.

Assembly 10 comprises a network connection device in the form of a patch panel 12. The patch panel 12 comprises a flat plate 14 that supports a plurality of cable terminations on its rear side (not shown). Each of the cable terminations is operatively connectable to a respected data cable for the transmission of data, and to a respective jack socket 16. The patch panel 12 may be a so-called PCB type, or may be virtually any other type of known patch panel.

The assembly further comprises a PoE control unit 18, and a power supply 20 operatively connected to the PoE control unit.

The assembly shown in FIG. 1 further comprises a PoE plug jack device 22 shown in more detail in FIG. 2. The PoE plug jack device 22 allows PoE connection between a network component and the PoE control unit 18 as is described in more detail herein below.

The PoE plug jack device 22 comprises a housing 23 which in this embodiment is generally cuboidal in shape. The PoE plug jack device 22 further comprises a male plug portion 24 which is operatively connected within the housing 23 and is shaped to engage with a respective jack socket 16. The male plug portion 24 may thus be plugged into a jack socket 16. Once the PoE plug jack device 22 has engaged with the jack socket 16 via the male plug portion 24, the connector is operatively connected to a data cable forming part of the patch panel device 12, via a data transmission path forming part of the patch panel 12.

The PoE plug jack device 22 further comprises a port 26 enabling a power cable 28 to be operatively connected to the PoE plug jack device 22. In the illustrated embodiment of the invention the port 26 not only allows the power cable 28 to be connected to the PoE plug jack device 22, but also includes a connection interface for AMPTRAC™ signals. The PoE plug jack device according to the invention may thus be used with commercial RJ45 plugs which have AMPTRAC signal capability. Such plugs include a pin carrying the AMPTRAC signal. The PoE plug jack device of the present invention allows transmission of an AMPTRAC signal from the RJ45 plug to the jack socket 16 in which a PoE plug jack device 22 is inserted.

AMPTRAC is a real-time intelligent structured cabling management system that provides an infrastructure management system for use in a network such as a LAN.

The PoE control unit 18 also comprises a power port (not shown) formed in the housing 23, and which enables the power cable 28 to also be operatively connected to the PoE control unit The PoE plug jack device 22 is thus directly connected to the PoE control unit and thereby to the power supply 20 independently of the patch panel 12.

This means that the PoE function may be provided to a predetermined outlet of the patch panel 12, by engaging a PoE plug jack device 22 with a predetermined socket 16 and then connecting the PoE plug jack device 22 to the PoE control unit 18 by means of the power cable 28. This avoids the expense of having to provide PoE function to other outlets in the panel 12 when such PoE function may not be required at the other outlets.

Although the power port 26 is shown as being formed on a rear face of the housing 23, the port 26 may be formed at any convenient part of the PoE plug jack device and may therefore be formed in a side face, upper face or lower face of the PoE plug jack device, for example.

If PoE function is required at other outlets of the patch panel 12, then it is necessary only to connect a further PoE plug jack device 22 to the appropriate socket 16 allowing PoE function to be provided to an additional outlet.

The PoE plug jack device 22 further comprises a network port 30 formed in the housing 23, and which allows a patch cable to be operatively connected to the PoE plug jack device 22.

The network port 30 thus allows a network component to be connected to the PoE function by the PoE plug jack device 22.

Contained within the housing 23 is an electronic section (not shown in the drawings). The electronic section may include one or more of, for example:
a filter;
a combiner;
a separator;
an inductance;
a sub-band communication apparatus;
an indicator apparatus; and/or
a power management device;
operatively connected to the male plug portion 24, the power port 26 and the network port 30.

The electronic section of the PoE plug jack device 22 allows mixing of data from a data cable, and a PoE signal from the PoE control unit to be mixed within the PoE plug jack device at an appropriate outlet of the patch panel, without the need to install for example, a frontal frame device onto the flat plate 14.

What is claimed is:

1-13. (canceled)

14. An assembly for permitting “Power-over-Ethernet” (PoE) connection between a PoE control device and a component of a cabling network, the assembly comprising:
a network connection device comprising a plurality of cable terminations that are each operatively connectable to a respective data cable for the transmission of data, and a plurality of sockets, each cable termination being operatively connected to a respective socket; and
a PoE plug jack device directly connectable to a PoE control device or PoE power source, such that, when directly connected to the PoE control device or the PoE power source, the PoE plug jack device receives power and/or power signals dependent on the output of the PoE control device or PoE power source, the PoE plug jack device being engageable with a respective socket, and thereby operatively connectable to the data cable via a data transmission path forming part of the network connection device.

15. An assembly according to claim 1, comprising a plurality of PoE plug jack devices, each PoE plug jack device being connectable to a respective socket, thereby to permit PoE connection between a PoE control device and a plurality of components of a cabling network.

16. An assembly according to claim 1, wherein the PoE plug jack device unit is connectable to a PoE control device or PoE power source via a power cable.

17. An assembly according to claim 1, wherein the PoE plug jack device comprises a power port for operatively connecting a power cable to the PoE plug jack device.

18. An assembly according to claim 1, further comprising a power cable attached to the PoE plug jack device.

19. An assembly according to claim 1, wherein the PoE plug jack device comprises a male plug portion engageable with the respective socket of the network connection device.

20. An assembly according to claim 1, wherein the PoE plug jack device further comprises a network port for operatively connecting a patch cable to the PoE plug jack device.

21. An assembly according to claim 1, wherein the PoE plug jack device includes within the housing an electronics section having one or more of:
a filter; a combiner; a separator; an inductance; a sub-band communication apparatus; an indicator apparatus; and/or a power management device operatively connected to the male plug portion of the PoE plug jack device.

22. An assembly according to claim 1, including a PoE control device operatively connected thereto and/or a power source operatively connected thereto.

23. An assembly according to claim 1, wherein the PoE plug jack device further comprises connection means for allowing the PoE plug jack device to be connected to a network connection device.

24. An assembly according to claim 10, wherein the connection means of the PoE plug jack device comprises a socket that duplicates a respective socket with which the PoE plug jack device is engageable.

25. In an assembly for permitting “Power-over-Ethernet” (PoE) connection between a PoE control device and a component of a cabling network, a PoE plug jack device is directly connectable to a PoE control device or PoE power source, such that, when directly connected to the PoE control device or the PoE power source, the PoE plug jack device receives power and/or power signals dependent on the output of the PoE control device or PoE power source, the PoE plug jack device being engageable with a respective socket, and thereby operatively connectable to a data cable via a data transmission path forming part of the network connection device.

26. A PoE plug jack device according to claim 12, having its own attached power cable, or means for attaching its own power cable, for direct connection to a PoE power source or PoE control device the device further comprising a connector for operatively connecting a network connection device to the PoE plug jack device, and a power port for operatively connecting the power cable to the PoE plug jack device.
